(19) United States
(12) Patent Application Publication
(10) Pub. No.: US 2011/0318613 A1
(43) Pub. Date: Dec. 29, 2011

(54) GALVANIC CELL COMPRISING SHEATHING II

(76) Inventors: Claus-Rupert Hohenthanner, Hanau (DE); Jens Meintschel, Bernsdorf (DE)

(21) Appl. No.: 13/145,631

(22) PCT Filed: Jan. 18, 2010
(86) PCT No.: PCT/EP2010/000257

§ 371 Date: Sep. 15, 2011

(30) Foreign Application Priority Data
Jan. 21, 2009 (DE) 10 2009 005 497.9
Oct. 14, 2009 (EP) 09012981.8

(51) Int. Cl. H01M 2/06; H01M 10/50; H01M 4/485; H01M 4/525; H01M 2/16; H01M 10/04; H01M 4/64; H01M 4/505; B82Y 30/00

(52) U.S. Cl. 429/50; 429/179; 429/120; 429/144; 29/623.1; 977/773

(57) ABSTRACT

The invention relates to a galvanic cell according to the invention with a substantially prismatic or cylindrical structure, said cell having a first electrode stack. A first current conductor is connected to a first electrode stack. In addition, the galvanic cell has sheathing that at least partially surrounds a first electrode stack. Part of a first current conductor extends from said sheathing. The galvanic cell also has a second electrode stack and a second current conductor. The sheathing has at least one first deep drawn part and one second deep drawn part. One of the deep drawn parts has a higher thermal conductivity than the other deep drawn parts. The deep drawn parts of the sheathing are provided to at least partially surround at least one electrode stack.

### DESCRIPTION

Priority application DE 10 2009 005 497.9 is fully incorporated by reference into the present application.

The present invention relates to a galvanic cell for a battery. The invention is described in connection with lithium-ion batteries for supplying motor vehicle drives. It is pointed out that the invention can also find use independently of the chemistry, the design of the galvanic cell or independently of the nature of the supplied drive.

Batteries with a plurality of galvanic cells for supplying motor vehicle drives are known from the prior art. During the operation of such a battery, irreversible chemical reactions also occur in the galvanic cells. These irreversible reactions lead to a reduced charging capacity of the galvanic cells.

The problem underlying the invention is to obtain the charging capacity of the galvanic cells of a battery over a greater number of charging cycles. According to the invention, this is achieved by the subject-matters of the independent claims. Preferred developments of the invention are the subject-matter of the sub-claims.

A galvanic cell according to the invention with, in particular, a substantially prismatic shape comprises at least a first electrode stack. The first current conductor is connected to a first electrode stack. In addition, the galvanic cell comprises a sheathing that at least partially surrounds the first electrode stack. The first current conductor extends partially out of the sheathing. Furthermore, the galvanic cell comprises a second electrode stack and a second current conductor. The sheathing comprises at least one first shaped partshaped part and one second shaped partshaped part. One of the shaped parts has a higher thermal conductivity than the other shaped parts. The shaped parts are provided to at least partially surround at least one electrode stack.

In the present case, a galvanic cell is understood to mean a device which is also used for the delivery of electrical energy. The galvanic cell stores the energy in chemical form. Before delivery of an electric current, the chemical energy is converted into electrical energy. The galvanic cell is potentially also suitable for absorbing electrical energy, converting it into chemical energy and storing it. One then speaks of a rechargeable galvanic cell. The conversion of electrical into chemical energy or vice versa is bound up with losses and is accompanied by irreversible chemical reactions. The effect of the irreversible chemical reactions is that regions of the galvanic cell are no longer available for energy storage and energy conversion. The storage capacity or charging capacity of the galvanic cell thus diminishes with an increasing number of discharging and charging processes or charging cycles. The irreversible chemical reactions also increase with an increasing operating temperature of a galvanic cell. The shape of a galvanic cell can be selected depending on the available space at the place of use. The galvanic cell is preferably substantially cylindrical or prismatic.

In the present case, an electrode stack is understood to mean the arrangement of at least two electrodes and an electrolyte arranged between the latter. The electrolyte can be taken up in part by a separator. The separator then separates the electrodes.

At least one electrode, particularly preferably at least one cathode, preferably comprises a compound with the formula LiMPO₄, wherein M is at least one transition metal cation of the first row of the periodic table. The transition metal cation is preferably selected from the group comprising Mn, Fe, Ni and Ti or a combination of these elements. The compound preferably has an olivine structure, preferably a higher-order olivine.

In a further embodiment, at least one electrode, particularly preferably at least one cathode, comprises a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide which contains manganese, cobalt and nickel.

The negative and the positive electrode are preferably separated from one another by one or more separators. Such separator materials can for example also comprise porous inorganic materials, which are constituted such that a substance transport can take place through the separator normal to the separator layer, whereas a substance transport parallel to the separator layer is hindered or even prevented.

Particularly preferred are separator materials which comprise a porous inorganic material which is interspersed with particles or comprises such particles at least at its surface, which melt when a temperature threshold is reached or exceeded and which at least locally reduce the size of or close pores of the separator layer. Such particles can preferably be made from a material selected from a group of materials which comprises polymers or mixtures of polymers, waxes or mixtures of these materials.

An embodiment of the invention is particularly preferred wherein the separator layer is constituted in such a way that its pores are filled due to a capillary effect with the mobile component that participates in the chemical reaction as an educt, so that only a relatively small part of the total quantity of the mobile component present in the galvanic cell is located outside the pores of the separator layer. In this connection, the electrolyte present in the galvanic cell or one of its chemical components or a mixture of such components is a particularly preferred educt which, according to a particularly preferred example of embodiment of the invention, wets or saturates the whole porous separator layer as far as possible, but which is not to be found or to be found only in a negligible or relatively small quantity outside the separator layer. In the production of the galvanic cell, such an arrangement can be obtained by the fact that the porous separator is saturated with the electrolyte present in the galvanic cell or with another educt of a suitably selected chemical reaction, so that this educt is subsequently present for the most part only in the separator.

If, on account of a chemical reaction, only a local increase in pressure possibly occurs initially due to the formation of a gas bubble or due to local heating, this educt cannot continue to flow out of other regions into the reaction region. Insofar as and as long as it can still continue to flow, the availability of this educt at other points is correspondingly reduced. The reaction finally comes to a stop or at least remains limited to a preferably small region.

According to the invention, use is preferably made of a separator which is not electron-conducting or only poorly so, and which comprises an at least partially substance-permeable carrier. The carrier is preferably coated on at least one side with an inorganic material. As an at least partially substance-permeable carrier, use is preferably made of an organic material which is preferably constituted as a non-woven fabric. The organic material, which preferably comprises a polymer and particularly preferably a polyethylene terephthalate (PET), is coated with an inorganic, preferably ion-conducting material, which in addition is preferably ion-conducting in a temperature range from −40° C. to 200° C. The inorganic material preferably comprises at least one compound from the group of oxides, phosphates, sulphates, titanates, silicates, aluminosilicates with at least one of the elements Zr, Al, Li, particularly preferably zirconium oxide. The inorganic, ion-conducting material preferably comprises particles with a maximum diameter of less than 100 nm.

Such a separator is marketed, for example, under the brand name “Separion” by Evonik AG in Germany.

The electrode stack is also used for the storage of chemical energy and for its conversion into electrical energy. In the case of a rechargeable galvanic cell, the electrode stack is also capable of converting electrical energy into chemical energy. For example, the electrodes are constituted plate-shaped or film-like. The electrode stack can also be coiled round and can have a substantially cylindrical shape. It is then more usual to speak of an electrode coil. In the following, the term electrode stack is also used for electrode coil. A first electrode stack and a second electrode stack are preferably constituted identically. The electrode stack can comprise lithium or another alkali metal also in ionic form.

In the present case, a current conductor is understood to mean a device which also enables the flow of electrons from an electrode in the direction of another electrically active device, in particular an electrical consumer. The current conductor also acts in the opposite current direction. A current conductor is connected in an electrically conductive manner to an electrode stack. A current conductor can be connected to a power lead. The shape of a current conductor is adapted to the shape of the galvanic cell or an electrode stack. A current conductor is preferably constituted plate-shaped and/or film-like. A first current conductor extends partially out of the sheathing. A second current conductor can extend partially out of the sheathing or can form a conductive connection between two electrode stacks. Each electrode of the electrode stack preferably comprises its own current conductor or electrodes of like polarity are connected to a common current conductor.

A current conductor is preferably partially coated, wherein the coating is constituted in particular so as to be electrically insulating.

In the present case, the sheathing is understood to mean a device which also hinders the exit of chemicals from the electrode stack into the surroundings. Furthermore, the sheathing protects the chemical components of the electrode stack against undesired interaction with the surroundings. For example, the sheathing protects the electrode stack against the admission of water or water vapour from the surroundings. The sheathing can be constituted film-like. The sheathing should impair the passage of thermal energy as little as possible. In the present case, the sheathing comprises at least two shaped parts. The sheathing is preferably at least partially adapted to the shape of the electrode stack.

In the present case, a shaped part is understood to mean a solid body which is adapted to the shape of an electrode stack. Depending on the circumstances, a shaped part does not acquire its shape until after the interaction with another shaped part and/or an electrode stack. In the case of a parallelepiped-shaped electrode stack, the shaped parts can be cut to shape so as to be substantially rectangular. Some dimensions of the shaped part are preferably selected larger than certain dimensions of an electrode stack. When two shaped parts are placed around the electrode stack, the shaped parts project partially beyond the electrode stack and partially form a projecting edge. An edge region of one shaped part preferably makes contact with an edge region of another shaped part, preferably in a two-dimensionally extending manner. One shaped part is constituted, for example, as a flat plate, whereas another shaped part fits snugly with the first shaped part around the electrode stack.

One shaped part has a higher thermal conductivity than the other shaped parts and partially makes contact with at least one electrode stack in a heat-conducting manner. Depending on the temperature difference between the shaped part and an electrode stack, thermal energy is transferred from an electrode stack or into an electrode stack.

A shaped part is preferably disposed between two electrode stacks and makes contact with both electrode stacks in a heat-conducting manner.

In the present case, surround is understood to mean that one shaped part can be brought into contact in sections with another shaped part. At least one electrode stack thereby lies between the shaped parts concerned. After the surrounding, at least two shaped parts make two-dimensionally extending contact with one another in sections, preferably at least along a limiting edge or an edge region of a shaped part concerned.

In order to supply a motor vehicle drive, high electric currents are withdrawn from time to time from the battery and can lead to marked heating of the galvanic cells of a battery. With increasing temperature, irreversible chemical reactions also increase in a galvanic cell. According to the invention, the sheathing of the galvanic cell is constituted by a shaped part which is characterised by a distinctly higher thermal conductivity than the other parts of the sheathing. The thermal resistance can thus be markedly reduced and the heat flow into the electrode stack or out of the electrode stack can be increased. A heat output in a galvanic cell with a smaller temperature difference can thus be carried away.

With the limitation of the operating temperature of a galvanic cell, irreversible chemical reactions are reduced, the charging capacity of the galvanic cell is for the most part retained, the operating life is increased and the underlying problem is solved.

Preferred embodiments of the invention are described below.

To advantage, at least two shaped parts of the sheathing are provided, to be connected to one another. The connection takes place, for example, in a friction-locked manner or preferably in a firmly bonded manner. Depending on the materials of the different shaped parts, the latter are connected to one another, for example, by gluing or a welding process. In particular, ultrasonic welding or laser welding can be used to connect at least two shaped parts. A preliminary treatment or activation of at least one of the surfaces of an involved shaped part may be useful here. A friction-locked or firmly bonded connection connects shaped parts in such a way that a peripheral strip-shaped connection preferably seals the space between the shaped parts with respect to the surroundings. In order to improve the adhesion, inserted strips can also be used, for example a sealing strip. At least two shaped parts are preferably connected to one another, particularly in a firmly bonded manner, in a first connection region. This first connection region preferably runs along an edge region of an involved shaped part. The first connection region is constituted strip-shaped. It is not necessary for the first connection region to run around completely along the limiting edges of the shaped part. Before the connection of the shaped parts concerned, other insertions parts can be disposed in such a way that the latter are also connected with the shaped parts in a friction-locked or firmly bonded manner. In particular, current conductors are inserted in such a way that the latter extend partially out of the sheathing. In the regions of the current conductors, the sheathing is thus also gas-tight with respect to the surroundings.

To advantage, at least one shaped part of the sheathing comprises a heat transfer region. This heat transfer region also serves to improve the heat transmission into an electrode stack or out of the latter. A first temperature-regulating medium preferably flows against the heat transfer region and/or the heat transfer region is in heat-conducting contact with a temperature-regulating element. The heat transfer region of a shaped part can also correspond to a predominant part of the surface of the shaped part. The heat transfer region can at the same time also be used to fix the galvanic cell to a temperature-regulating element, for example by screws, rivets, gluing or welding.

At least one shaped part of the sheathing is preferably constituted flexurally stiff. This shaped part can provide support for an electrode stack, protect the electrode stack against mechanical damage or be used for the mechanical connection of the galvanic cell with the receiving device. This shaped part is preferably constituted as a metal plate or a sheet metal. The shaped part can be stiffened for example by crimping, upturned edge regions or ribs.

At least one shaped part of the sheathing is preferably constituted thin-walled. The wall thickness is preferably constituted for adaptation of the at least one shaped part to mechanical, electrical or thermal stressing. The wall thickness does not have to be uniform. A region of a thin-wall shaped part with a greater wall thickness can act as a heat sink or heat reservoir and thus contribute towards thermal energy being carried away from the electrode stack or transported into the latter. The thin-wall design of a shaped part also saves on weight and space. At least one shaped part is preferably constituted as a film, particularly preferably as a composite film. Metals or plastics can also be considered as materials for the composite film.

At least one shaped part of the sheathing preferably comprises a coating at least in sections. This coating is also used for adaptation to stresses to which the shaped part is subjected. For example, the coating is used for electrical insulation, for protecting the shaped part against the chemicals of the galvanic cell, for improving adhesion for an adhesive joint, for improving the thermal conductivity or for protection against damaging effects from the surroundings. A coating can produce a chemical activation of the surface of the shaped part. A coating is preferably made from a material which differs from the material of the shaped part. The at least one shaped part can also comprise a plurality of different coatings, which can also be disposed at different places on the shaped part. If a shaped part is in electrical contact with an electrode stack, a current conductor is preferably electrically insulated with respect to this shaped part.

To advantage, at least one shaped part of the sheathing comprises a cutout, in particular a shell. With this embodiment, the shaped part also acquires an increased planar moment of inertia or flexural strength. This cutout preferably at least partially accommodates an electrode stack. This also serves to protect an electrode stack. The wall thickness of a shaped part with a cutout is preferably adapted to the stress. A plurality of shaped parts of the sheathing can comprise cutouts, which jointly form a space for accommodating an electrode stack. One shaped part is preferably constituted as a deep-drawn or cold-extruded sheet metal. One shaped part is preferably constituted as a deep-drawn plastic sheet, a composite film or a plastic film. A shaped part of the sheathing with a cutout additionally comprises at least a first connection region, which is provided for the connection with another shaped part.

To advantage, at least one shaped part comprises a second connection region. The second connection region is also used for fixing the galvanic cell, for example in a housing, in a frame or on a base plate. A second connection region is preferably constituted such that the connection of the shaped part concerned with another body takes place only in a predetermined manner.

For example, a second connection region has a geometrical shape which corresponds to a region of another body.

The connection between the shaped part and the other body only in a predetermined manner can preferably be achieved by means of an arrangement of shaped elements, for example holes and pegs. The arrangement of through-holes or threads can also permit a connection only in a predetermined manner. A second connection region is preferably spatially separated from a first connection region. At least one shaped part of the sheathing preferably comprises a plurality of separated second connection regions. The connection of the shaped part with another body takes place, for example, by means of rivets, screws, welding or gluing. A second connection region of a shaped part and a heat transfer region thereof preferably coincide. In these regions, the shaped part is connected, for example, to a temperature-regulating element, a frame or to a base plate of the battery housing.

To advantage, at least two electrode stacks of a galvanic cell according to the invention are connected to one another in an electrically conductive manner. The electrically conductive connection can be produced indirectly via the current conductors of the electrode stacks. The connection can produce an electrical series connection of the electrode stacks or their connection in parallel.

In each case, a first current conductor is connected to a first electrode stack and a second current conductor is connected to a second electrode stack. When both current conductors extend partially out of the sheathing, the electrically conductive connection of the current conductors and the electrode stacks can take place outside the sheathing. For example, two current conductors project beyond the edge of a shaped part. At least one current conductor can thereby extend in the direction of another current conductor and can partially make contact with or be connected to the latter in an electrically conductive manner. Furthermore, at least one current conductor can be partially coated in an electrically insulating manner.

To advantage, at least one shaped part comprises at least one opening, in particular inside the sheathing. An opening is bounded by edges which are preferably coated in an electrically insulating manner. A second current conductor is passed through an opening of a shaped part. A second current conductor is preferably constituted so as to seal an opening and/or is partially coated in an electrically insulating manner. A region of a second current conductor is connected at least partially in an electrically conductive manner to a first current conductor. At least two electrode stacks are preferably connected electrically in series. A galvanic cell with two electrode stacks can also comprise only two brought-out current conductors of differing polarity.

To advantage, at least two galvanic cells are grouped to form a battery. The at least two galvanic cells are preferably arranged parallel to one another. Prismatic or parallelepiped-shaped cells are preferably brought into contact with one another in a two-dimensionally extending manner and can form a substantially parallelepiped-shaped pack.

At least one temperature-regulating element is also assigned to the battery. The temperature-regulating element has a predetermined temperature, which may be variable over time. The temperature of the temperature-regulating element is preferably selected depending on the temperature of an electrode stack of a galvanic cell. A predetermined temperature gradient causes a heat flow into this electrode stack or out of this electrode stack. The temperature-regulating element exchanges thermal energy with the electrode stack via at least one shaped part or its heat transfer region, which is in contact with the temperature-regulating element. The existing galvanic cells can also be connected to the temperature-regulating element, in particular in a friction-locked or firmly bonded manner, via a second connection region.

To advantage, the temperature-regulating element comprises at least a first channel also for the adjustment of a preset temperature of the temperature-regulating element. This channel is preferably filled with a second temperature-regulating medium. A second temperature-regulating medium particularly preferably flows through this at least one channel. The flowing second temperature-regulating medium supplies thermal energy to the temperature-regulating element or removes thermal energy from the latter. The at least one temperature-regulating element is preferably in an active connection with a heat exchanger. The heat exchanger carries away thermal energy from this temperature-regulating element or supplies thermal energy to this temperature-regulating element, in particular by means of the second temperature-regulating medium. The heat exchanger and the temperature-regulating medium can also interact with the air-conditioning system of a motor vehicle. The heat exchanger can comprise an electric heating unit.

To advantage, a battery with at least two galvanic cells is operated in such a way that a first temperature-regulating medium flows against at least one shaped part of a galvanic cell. For example, ambient air or a coolant of the air-conditioning system of the motor vehicle is used as the first temperature-regulating medium. The first temperature-regulating medium can have a higher or lower temperature than the at least one shaped part, its heat transfer region, or than an electrode stack.

To advantage, a galvanic cell according to the invention is produced in such a way that at least two shaped parts of the sheathing are first placed together around an electrode stack. The current conductors of the galvanic cell can thereby be inserted. The two shaped parts are then connected to one another, especially in a firmly bonded manner, so that an, in particular, peripheral connection of at least two shaped parts is produced. A gas-tight sheathing around the electrode stack is thus preferably produced.

At least one shaped part is then transferred into a deformed state by bending, especially by upturning at least one edge region of the shaped part. The first connection region is preferably at least partially bent. A dimension of the at least one shaped part can thereby be reduced. To advantage, the upturned regions of the shaped part provide an additional mechanical protection of the electrode stack. To advantage, an upturned edge region increases the planar moment of inertia of the shaped part concerned.

Further advantages, features and possible applications of the present invention emerge from the following description in connection with the figures. In the figures:

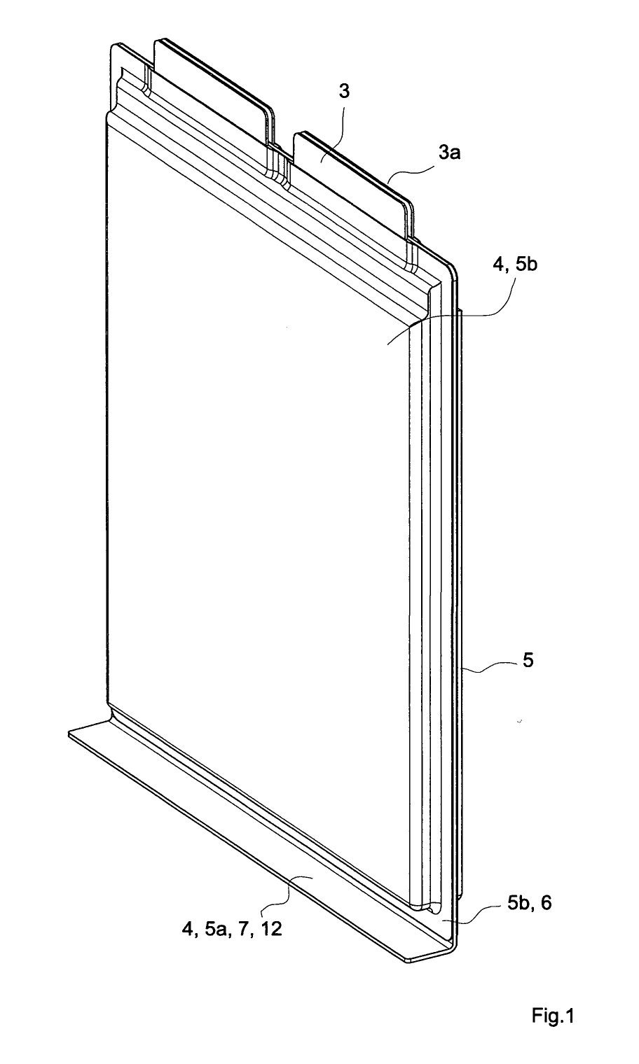

FIG. 1 shows a perspective view of a galvanic cell according to the invention with two electrode stacks.

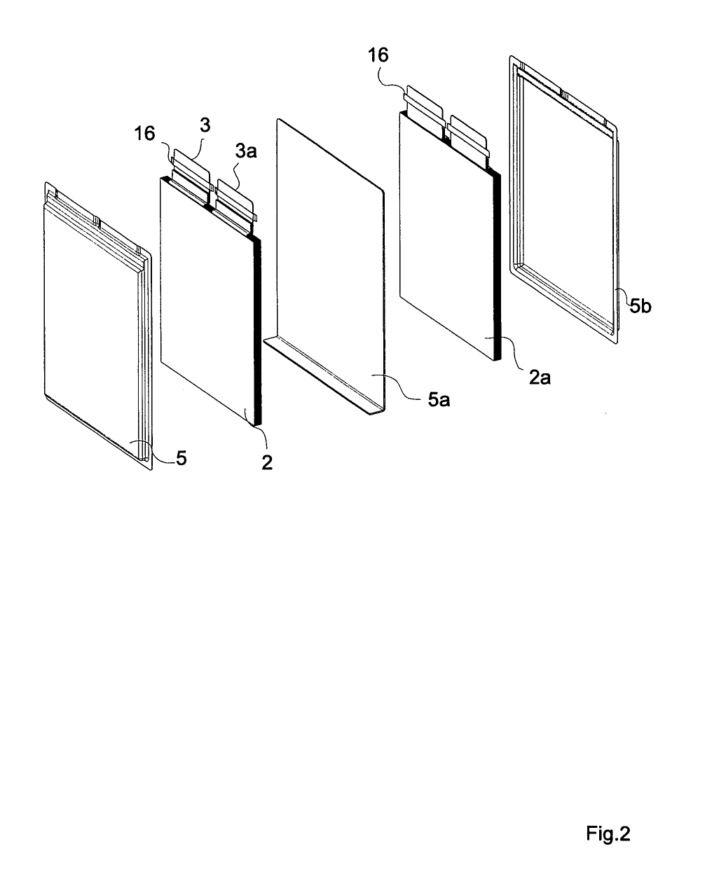

FIG. 2 shows an exploded view of a galvanic cell according to the invention with two electrode stacks.

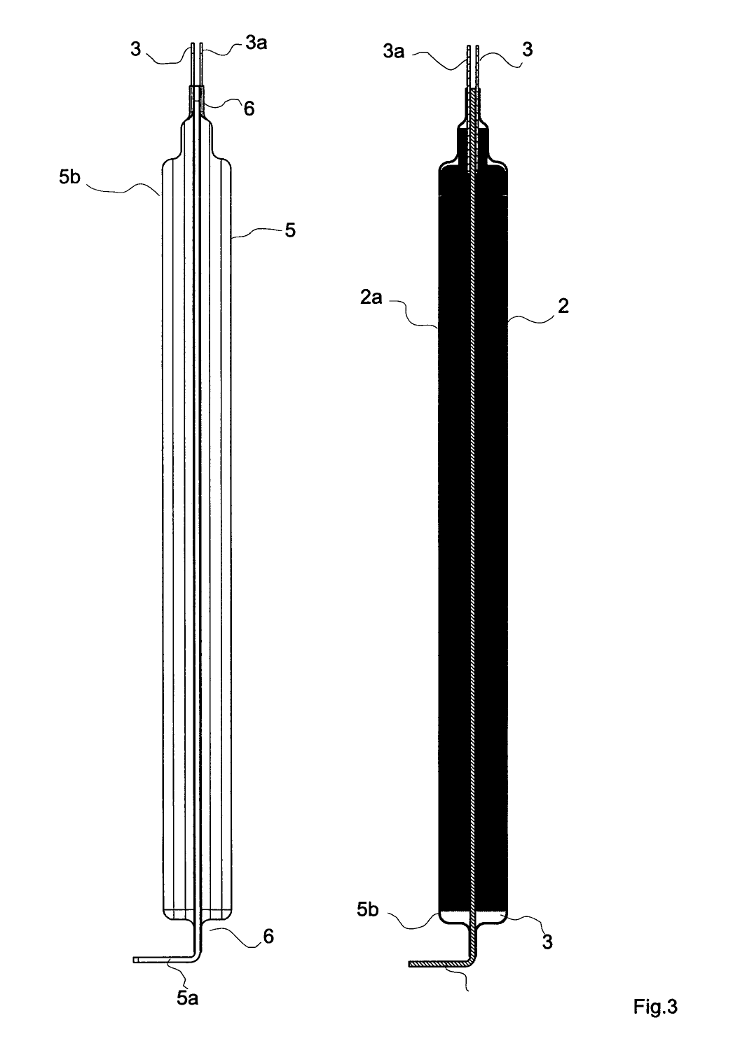

FIG. 3 shows a side view and a section through a galvanic cell according to the invention with two electrode stacks.

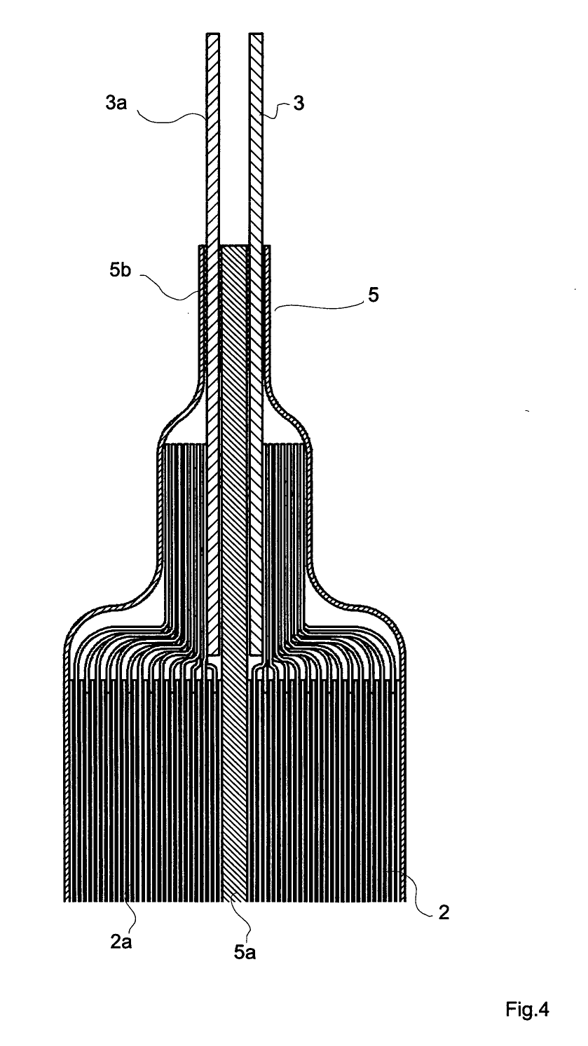

FIG. 4 shows, as an enlarged detail, a section through a galvanic cell according to the invention with two electrode stacks.

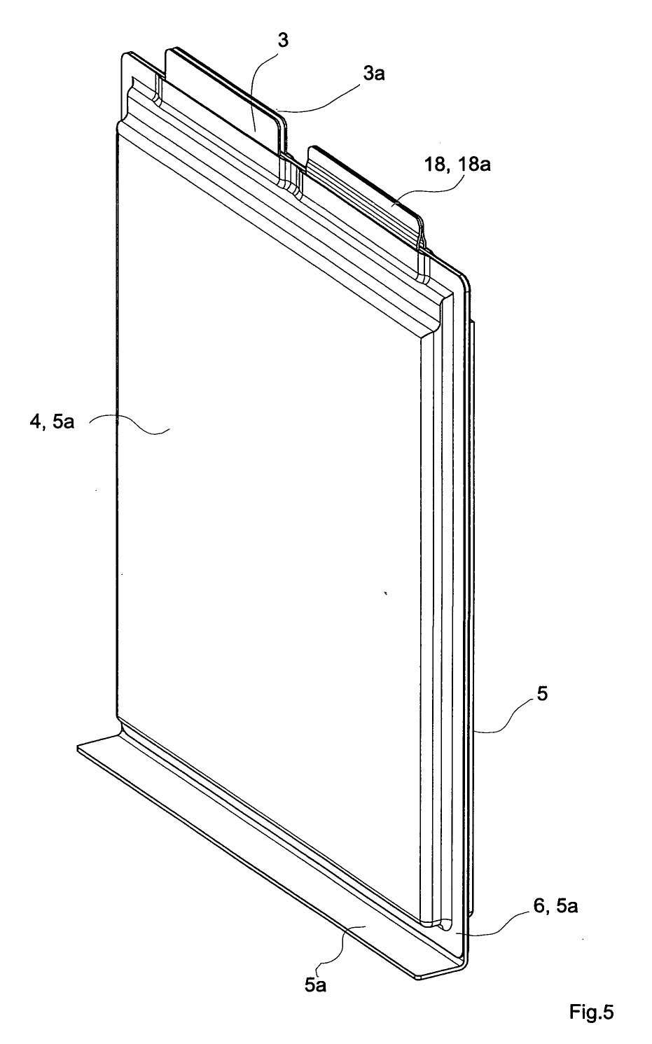

FIG. 5 shows a perspective view of a galvanic cell according to the invention with two electrode stacks with connected current conductors.

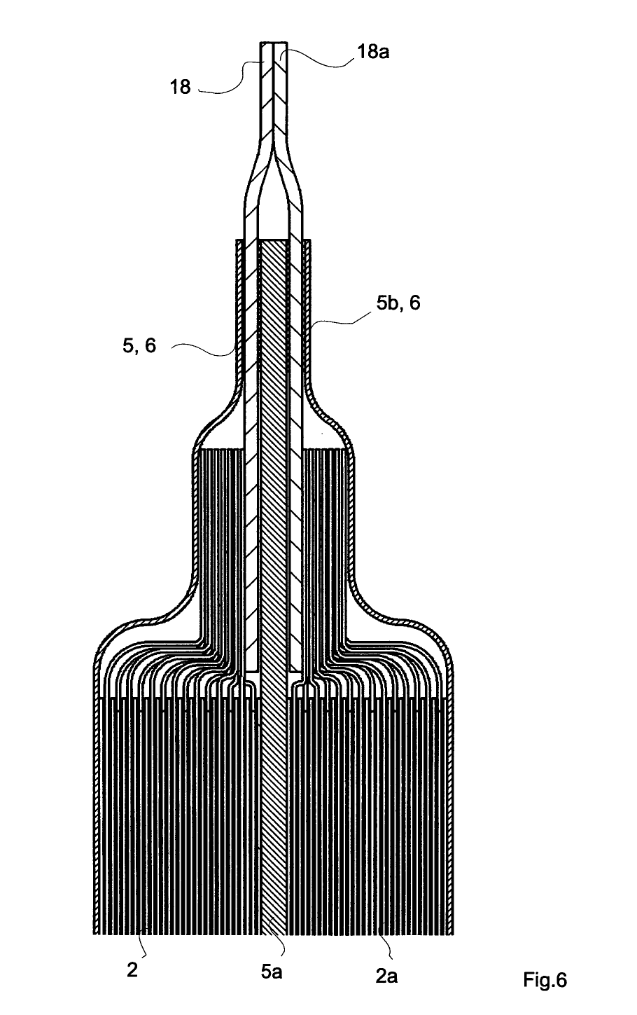

FIG. 6 shows, as an enlarged detail, a section through a galvanic cell according to the invention with two electrode stacks and connected current conductors.

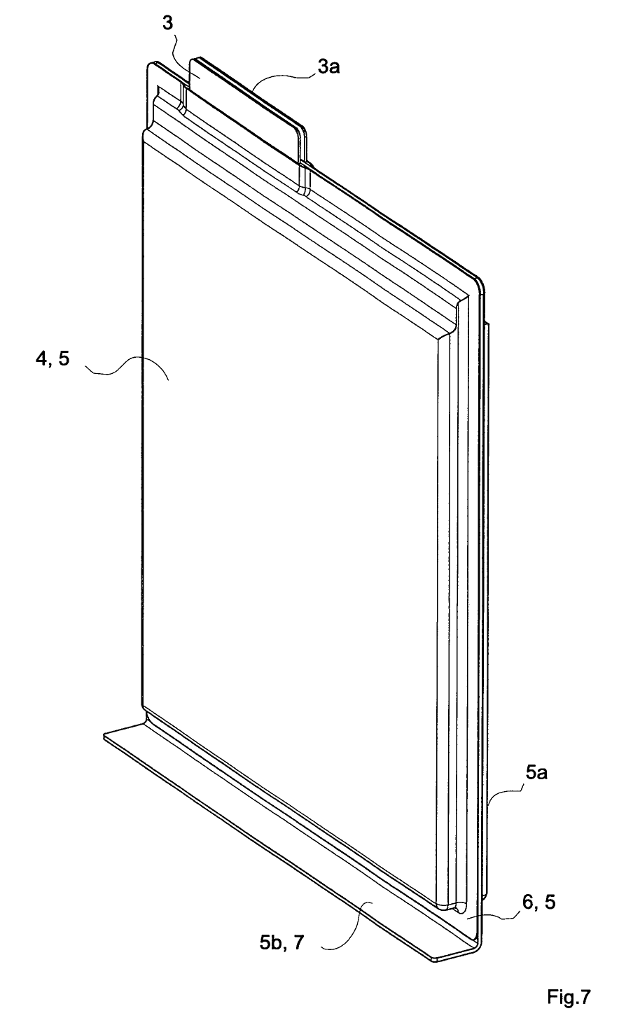

FIG. 7 shows a galvanic cell according to the invention with two electrode stacks, which are connected electrically in series internally.

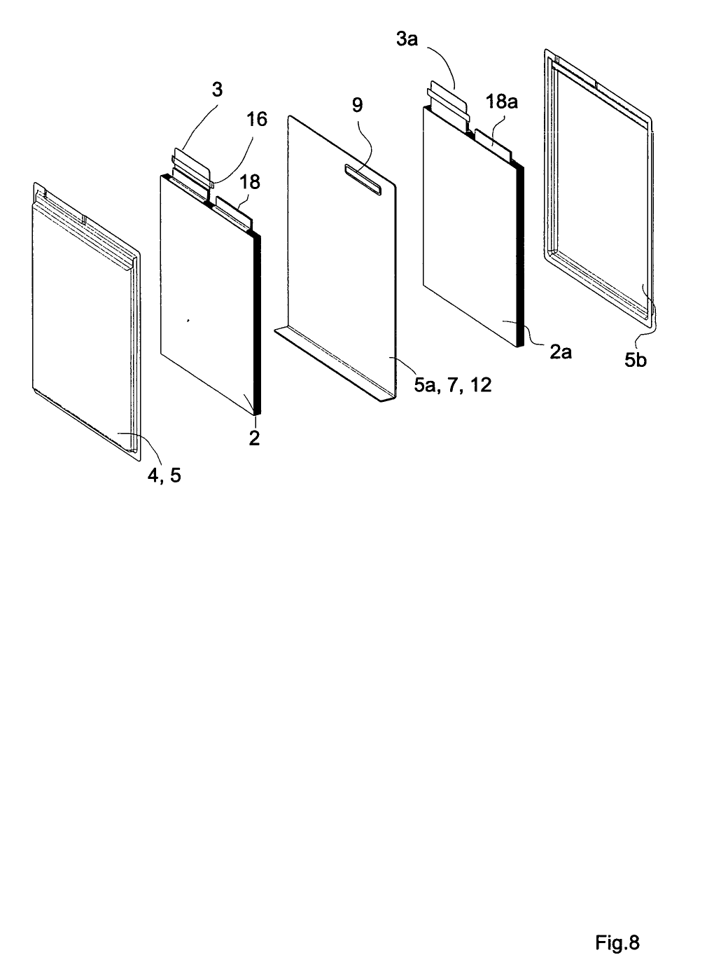

FIG. 8 shows an exploded view of the galvanic cell from FIG. 7.

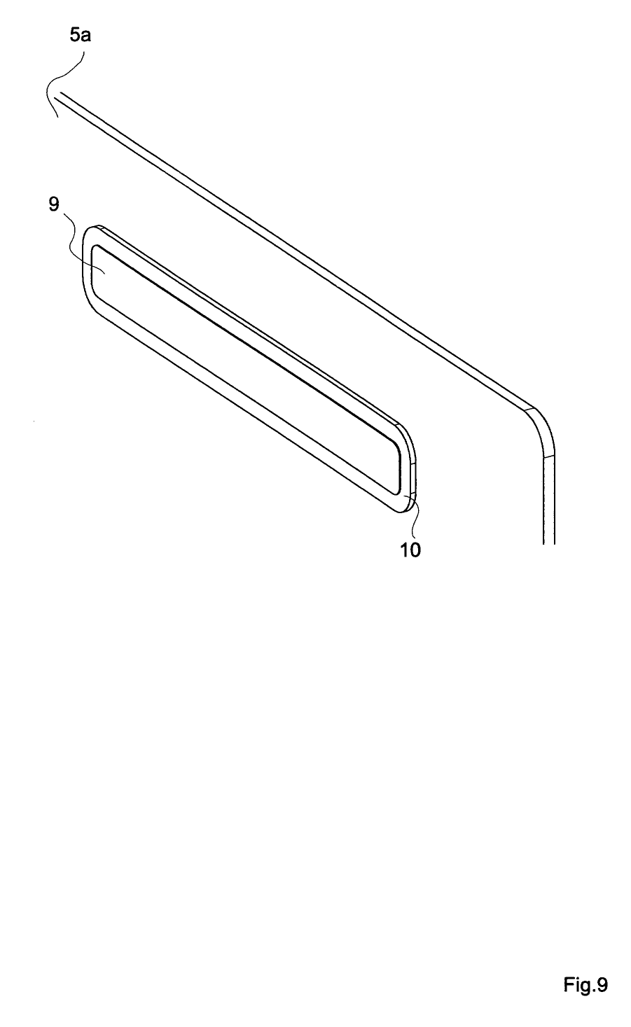

FIG. 9 shows a perspective view of a shaped part with an opening of the galvanic cells from FIGS. 7 and 8.

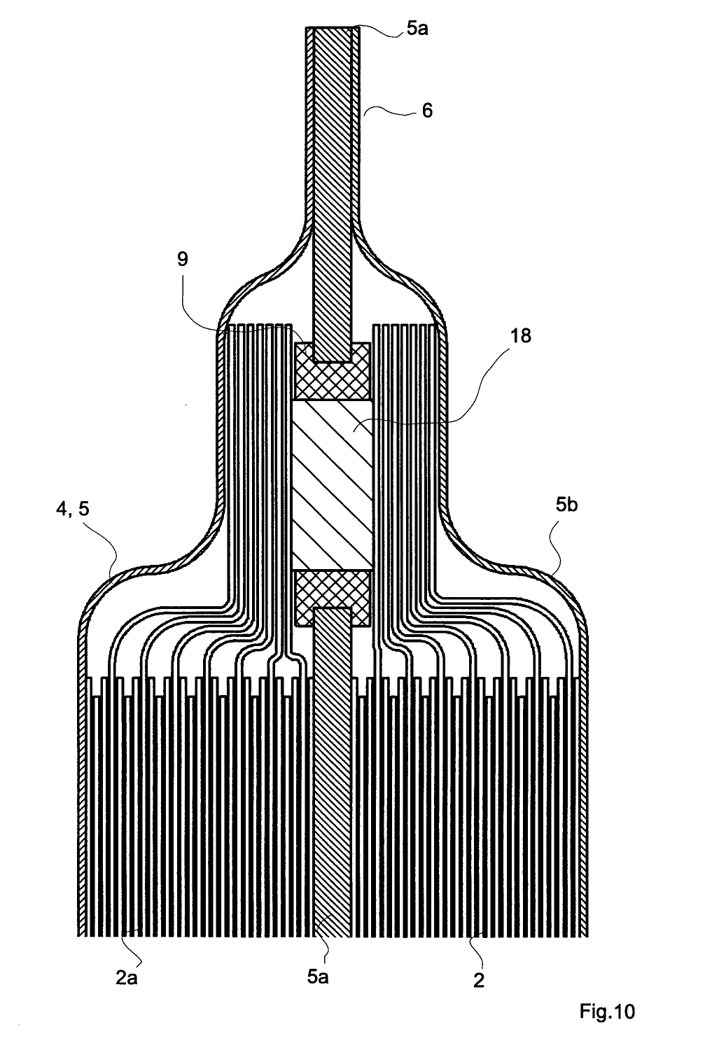

FIG. 10 shows an enlarged detail of a galvanic cell according to the invention with two electrode stacks and an inner connection in series.

FIG. 1 shows a galvanic cell according to the invention with two electrode stacks. Shaped part 5a is constituted as a metal plate. Shaped part 5a is partially bent over along the lower edge. The upturned region acts as heat transfer region 7 and as second fixing region 12. An electrode stack (not represented) is disposed respectively on both sides of shaped part 5a. First current conductors 3, 3a are connected to the first electrode stack. Said current conductors extend partially out of sheathing 4. Sheathing 4 also comprises two other shaped part 5, 5b, which are connected in a firmly bonded manner by means of a first connection region 6 to shaped part 5a disposed between the latter. The electrode stacks are thus secured against slipping. Shaped part 5a supports the electrode stack. Furthermore, shaped part 5a serves to exchange thermal energy with the electrode stacks of the galvanic cell. A temperature-regulating element is not represented, to which shaped part 5a is connected in a firmly bonded manner by means of second connection region 12 and in a heat-conducting manner by means of heat transfer region 7.

FIG. 2 shows a galvanic cell according to the invention with two electrode stacks 2, 2a before the sheathing is closed. It is also shown that, before the firmly bonded connection is produced, sealing strips 16 are laid jointly with current conductors 3, 3a between shaped parts 5, 5a, 5b.

FIG. 3 shows a side view of a galvanic cell according to the invention with two electrode stacks according to FIG. 1. Electrode stacks 2, 2a can be seen in the sectional representation of the figure. The latter each comprise a plurality of anode layers, cathode layers and separator layers. The electrolyte is partially taken up by the separator layers.

FIG. 4 shows, as an enlargement, a part of the galvanic cell from FIG. 3. It is shown that an electrode stack comprises numerous anodes and cathodes, which are connected by current leads to first current conductors 3, 3a. In this case, the connection is produced by welding. It is also shown that electrodes 2, 2a are disposed on both sides of shaped part 5a and make contact with this shaped part 5a in a heat conducting manner.

FIG. 5 shows a galvanic cell according to the invention with two electrode stacks which are connected to one another electrically. For this purpose, the two current conductors 18, 18a are connected to one another outside sheathing 4 in a firmly bonded and electrically conductive manner. The electrode stacks are connected in series by the connection of two current conductors of differing polarity.

FIG. 6 shows an enlarged detail of the galvanic cell from FIG. 5. It is shown that second current conductors 18, 18a are bent above shaped part 5a, in such a way that they come into contact with one another in a two-dimensionally extending and electrically conductive manner.

FIG. 7 shows a galvanic cell according to the invention with electrode stacks which are connected to one another. Only two first current conductors 3, 3a of differing polarity project from sheathing 4. It is not shown that the two electrode stacks are connected in an electrically conductive manner inside sheathing 4 by means of a second current conductor and are connected in series. The connection can also be constituted as a parallel connection.

FIG. 8 shows a galvanic cell from FIG. 7 before sheathing 4 is closed. Shaped part 5a disposed in the middle and constituted as a sheet metal comprises an opening 9. The edges of this opening are coated 10 in an electrically insulating manner. Second current conductors 18, 18a are constituted in such a way that they make contact with one another in an electrically conductive manner in the region of the window of opening 9. The two current conductors 18, 18a do not project out of sheathing 4.

FIG. 9 shows, as an enlarged detail, flexurally stiff shaped part 5a, constituted as a sheet metal, with opening 9. Also shown is section-wise coating 10 of shaped part 5a along the edges of opening 9. This coating 10 is constituted by a polymer material so as to be electrically insulating.

FIG. 10 shows an alternative embodiment of the galvanic cell according to FIG. 7. An enlarged detail in the region of opening 9 in shaped part 5a is represented. The two electrode stacks 2, 2a are welded by conductor tabs to a second current conductor 18. Second current conductor 18 is disposed inside opening 9. Second current conductor 18 is separated electrically with respect to shaped part 5a by means of insulating coating 10. Coating 10 and second current conductor 18 are matched to one another in terms of their dimensions, in such a way that second current conductor 18 also seals opening 9. The two spaces of sheathing 4, which accommodate electrode stacks 2, 2a, can each be hermetically sealed.

1-18. (canceled)

19. A galvanic cell with, in particular, a substantially prismatic structure at least comprising:
at least a first electrode stack,
at least a first current conductor which is connected to a first electrode stack, and
a sheathing which at least partially surrounds at least a first electrode stack, wherein the at least one current conductor extends partially out of the sheathing, wherein:
the sheathing comprises at least one first shaped part and at least one second shaped part, which partially surround at least one electrode stack, wherein one of these shaped parts has a higher thermal conductivity than the other shaped parts, and wherein this shaped part makes contact in a heat-conducting manner with at least one electrode stack.

20. The galvanic cell according to claim 19, characterised in that the galvanic cell further comprises at least a second electrode stack and at least a second current conductor, and that the shaped parts are further provided to at least partially surround at least one electrode stack.

21. The galvanic cell according to claim 20, wherein at least two shaped parts of the sheathing are provided, to be connected to one another at least partially and in particular in a firmly bonded manner in a first connection region.

22. The galvanic cell according to claim 19, wherein at least one shaped part of the sheathing comprises a heat transfer region, which is provided in particular for making contact with a temperature-regulating element and/or with a first temperature-regulating medium.

23. The galvanic cell according to claim 19, wherein at least one shaped part of the sheathing is constituted flexurally stiff and/or that at least one shaped part of the sheathing s constituted thin-walled.

24. The galvanic cell according to claim 19, wherein at least one shaped part of the sheathing comprises a coating at least in sections.

25. The galvanic cell according to claim 19, wherein at least one shaped part of the sheathing comprises a cutout, in particular for accommodating an electrode stack.

26. The galvanic cell according to claim 19, wherein at least one shaped part of the sheathing comprises a second connection region.

27. The galvanic cell according to claim 20, wherein at least a first current conductor is connected to at least a first electrode stack,
that at least a second current conductor is connected to at least a second electrode stack,
and that at least a second current conductor is connected to at least a first current conductor or to at least to a first electrode stack.

28. The galvanic cell according to claim 27, wherein at least one shaped part comprises an opening,
that at least a second current conductor is passed through the opening,
and that at least a second current conductor is connected to at least a first current conductor or at least to a first electrode stack, in particular inside the sheathing.

29. The galvanic cell according to claim 19, comprising at least one electrode stack which comprises at least one electrode, preferably at least one cathode, which comprises a compound with the formula LiMPO₄, wherein M is at least one transition metal cation of the first row of the periodic table, wherein this transition metal cation is preferably selected from the group comprising Mn, Fe, Ni and Ti or a combination of these elements, and wherein the compound preferably has an olivine structure, preferably a higher-order olivine, wherein Fe is particularly preferred; and/or that it comprises at least one electrode stack which comprises at least one electrode, preferably at least one cathode, which comprises a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide which contains manganese, cobalt and nickel.

30. The galvanic cell according to claim 19, comprising at least one electrode stack which comprises at least one separator which is not electron-conducting or only poorly so, and which comprises an at least partially substance-permeable carrier, wherein the carrier is preferably coated on at least one side with an inorganic material, wherein, as an at least partially substance-permeable carrier, use is preferably made of an organic material which is preferably constituted as a non-woven fabric, wherein the organic material preferably comprises a polymer and particularly preferably a polyethylene terephthalate (PET),
wherein the organic material is coated with an inorganic, preferably ion-conducting material, which in addition is preferably ion-conducting in a temperature range from −40° C. to 200° C., wherein the inorganic material preferably comprises at least one compound from the group of oxides, phosphates, sulphates, titanates, silicates, aluminosilicates with at least one of the elements Zr, Al, Li, particularly preferably zirconium oxide, and wherein the inorganic, ion-conducting material preferably comprises particles with a maximum diameter of less than 100 nm.

31. A battery with at least two galvanic cells according to claim 19, wherein
the galvanic cells are disposed substantially parallel to one another,
and that at least one temperature-regulating element is assigned to the battery, wherein at least one temperature-regulating element is provided for making contact with at least one shaped part of the sheathing of at least one of the galvanic cells.

32. The battery according to claim 31, wherein the at least one temperature-regulating element comprises at least a first channel, which is preferably filled with a second temperature-regulating medium, and/or wherein the at least one temperature-regulating element is in an active connection with a heat exchanger.

33. A method for operating a battery according to claim 32, comprising selecting the temperature of the temperature-regulating element depending on the desired operating temperature of the galvanic cells of the battery, flowing the second temperature-regulating medium through at least a first channel of the temperature-regulating element, and flowing a first temperature-regulating medium against or partially around at least one shaped part, in particular a heat transfer region of a shaped part.

34. A method for producing a galvanic cell according to claim 19, comprising connecting at least two shaped parts of the sheathing to one another, in particular in a firmly bonded manner,
and transferring that at least one shaped part of the sheathing from an initial state by bending into a deformed state, wherein at least one extension of the shaped part is reduced in the deformed state compared to the initial state.

35. The galvanic cell according to claim 20, wherein at least one shaped part of the sheathing comprises a heat transfer region, which is provided in particular for making contact with a temperature-regulating element and/or with a first temperature-regulating medium.

36. The galvanic cell according to claim 20, wherein at least one shaped part of the sheathing is constituted flexurally stiff and/or that at least one shaped part of the sheathing s constituted thin-walled.

37. The galvanic cell according to claim 20, wherein at least one shaped part of the sheathing comprises a coating at least in sections.

38. The galvanic cell according to claim 20, wherein at least one shaped part of the sheathing comprises a cutout, in particular for accommodating an electrode stack.

39. The galvanic cell according to claim 20, wherein at least one shaped part of the sheathing comprises a second connection region.
